(19) United States
(12) Patent Application Publication
(10) Pub. No.: US 2020/0265596 A1
(43) Pub. Date: Aug. 20, 2020

(54) METHOD FOR CAPTURED IMAGE POSITIONING

(71) Applicants: Kyrylo HORBAN, Kiev (UA); Valentyna HORBAN, Kiev (UA); Livii IABANZHI, Nikolaev (UA); Viacheslav POPIKA, Volinskaya Oblast (UA)

(72) Inventors: Kyrylo HORBAN, Kiev (UA); Valentyna HORBAN, Kiev (UA); Livii IABANZHI, Nikolaev (UA); Viacheslav POPIKA, Volinskaya Oblast (UA)

(21) Appl. No.: 16/401,140

(22) Filed: May 2, 2019

(30) Foreign Application Priority Data
Feb. 14, 2019 (UA) U201901480
Mar. 5, 2019 (UA) U201902256

(51) Int. Cl. G06T 7/33; G06T 7/13; G06T 5/00; G06T 5/50; G06K 9/32; G06F 17/18

(52) U.S. Cl. CPC G06T 7/337; G06T 7/13; G06T 5/003; G06T 2207/20081; G06K 9/3241; G06F 17/18; G06T 5/50

(57) ABSTRACT

The disclosed technical solution relates to methods of digital data processing. In particular, the disclosed method relates to methods of digital image processing. According to the method a detected image with an identified object and object attributes is called up on a screen. Then the reference image parameters are superimposed on the detected image and recommendations for adjusting the captured image position are generated. As a result, the position of the detected image on the screen is changed until the position of the identified object coincides with the parameters of the reference image. The technical result is an increased accuracy of the detected image position before saving in a memory.

### CROSS-REFERENCE TO RELATED APPLICATIONS

The present application claims priority to Ukrainian patent applications u201901480 filed Feb. 14, 2019 and u201902256 filed on Mar. 5, 2019.

### TECHNICAL FIELD

The claimed technical solution relates to methods of digital data processing. In particular, the claimed method relates to methods of digital image processing.

### BACKGROUND

Hand-held devices such as mobile telephones, cameras and other image capture devices or devices equipped with video cameras, which allow the users to takes photographs of scenes and events. Often, during shooting of object or narrative photos (including ones with participation of people) the users do not obtain optimal images.

Often, when applying graphics editors for producing or editing graphic images or 3D scenes the users are not always able to create optimal arrangement of objects for further application of images beyond the frames of graphics editors.

For example, images of objects, commodities which are used, consumed or perceived by people may be asymmetrical, an object may be insufficiently or improperly lighted, the angle of its shooting may be incorrectly chosen or taken images may poor harmonize by color or be unbalanced relatively each other.

In creating an image the user must use some rules of composition which are generally (in particular for amateurs) unknown. This fact results in poor quality of the image and demands more time for repeated creation of the image.

From the related arts the international patent publication WO2015123605A1 ‘Photo composition and position guidance in an imaging device’ is known in which a method for positioning captured images is disclosed. According to it an image received on a capturing device is detected. The image is analyzed with the use of a processor module for identification of objects and determination of the objects attributes. Using the processor module proposals for correcting the image in accordance with the rules specified for analysis of images are offered. Based on the offered proposals and with the use of the processor module the corrections are implemented and the corrected image is obtained.

A disadvantage of the known solution is its low information content due to the fact that the proposals offered to the user for adjusting the detected image received on the capturing device are based on the pre-defined templates and do not envisage any possible refinement of the composition.

### SUMMARY

The disclosed technical solution has an object to provide such a method for positioning captured images which ensures the automated adaptation of a detected image to the predetermined composition rules.

The set task is solved by a method for positioning captured images that comprises stages at which

an image received on a capturing device is detected;
the image is analyzed by the processor module to identify objects and determine attributes of the objects;
suggestions to adjust the image in accordance with the rules established for the analysis of images by the processor module are provided;
adjustments based on the provided suggestions for receiving an adjusted image are implemented with the use of the processor module,
according to the technical solution,
an array of object template masks, an array of object attributes, an array of pre-defined parametric grids of reference images and a screen for displaying images are applied, at that
images on a capturing device are detected on-line
a degree of sharpness of the image is determined by detecting edges of objects on the picture and adjusting to the pre-defined limit degree of sharpness,
   the corresponding mask for identification of an object is called up from the array of template masks with the use of the processor module where the object mask is characterized by an array of control values that define the type and position of the object, and a set of characteristics for defining attributes of each object is called up from the array of object attributes, then the detected image with a set of identified objects and each object attributes is called up on the screen from the set of objects, according to the analysis of the image the parametric grid of reference image form the pre-defined parametric grids of reference images if defined,
   the parametric grid of reference image form the pre-defined parametric grids of reference images is online superimposed on the detected image with accounting for the determined attributes of each object from the set of detected objects,
   values of deviations between the attributes of each object from the set of detected objects and the parametric grid of reference image are determined,
   the recommendations for positioning the captured image are renewed by an algorithm of recommendations on the basis of the input data for adaptive systems with accounting for the determined value of deviation,
   the position of the detected image on the screen is changed until coincidence of the position of the identified object and the parameters of reference image,
   the obtained image is saved in the memory.

The technical result that is attained by embodiments of the disclosed technical solution is an increased accuracy of positioning of the detected image before its saving. This allows the user to take fewer shots before obtaining an optimal picture or perform fewer operations on processing the detected image.

### BRIEF DESCRIPTION OF DRAWINGS

The disclosed technical solution may be best understood with the use of the accompanying drawings. The accompanying drawings are not restrictive and listed for explanation of the possibility of implementation of the method and potentiality of its improvement.

FIG. 1 shows a displayed prompt for the user when the detected image does not correspond with the selected composition.

FIG. 2 shows a displayed prompt to indicate a new precise position of the object that falls outside the limits of the composition design.

FIG. 3 shows a point of creation of the final composition.

### DETAILED DESCRIPTION OF THE PREFERRED EMBODIMENT

For unambiguous understanding of the essence of the method for positioning captured images it is necessary to give more detailed description of the following terms.

The capturing device may be a digital camera, a mobile device, such as a personal computer with an available camera, a mobile phone or other camera equipped devices.

The processor module means an electronic programmable module that is designed to perform operations with digital data. Such a processor module may be a processor <a videochip, a microcontroller, FPGA, ASIC, a cloud server.

The screen means a device for displaying visual information.

The array of template masks means standardized pre-defined data on the available objects. The objects include at least one of animate or inanimate objects including background, people, buildings, birds, animals, things or combinations thereof.

The array of attributes means characteristics of an object that has been captured in the detected image. Such attributes include: brightness, a focal distance, color etc.

The array of pre-defined parametric grids of reference images means a set of auxiliary grids constructed within the screen on the basis of the pre-defined composition templates. Such composition templates include the templates constructed with the use of the rule of thirds, the rule of diagonal, the rule of golden proportions, the rule of scaling etc. The user may select the parametric grids of reference images manually or switch on an automated selection of these parametric grids of reference images.

According to the disclosed method an image received on the capturing device is identified in real time. The identified image may be processed on the image capture device. In addition, the identified image may be sent to a device for processing this identified image. The processing device may be an electronic computer such as a personal computer, a tablet personal computer, a smart phone and any other that has an access to Internet or other channels of wire or wireless communication.

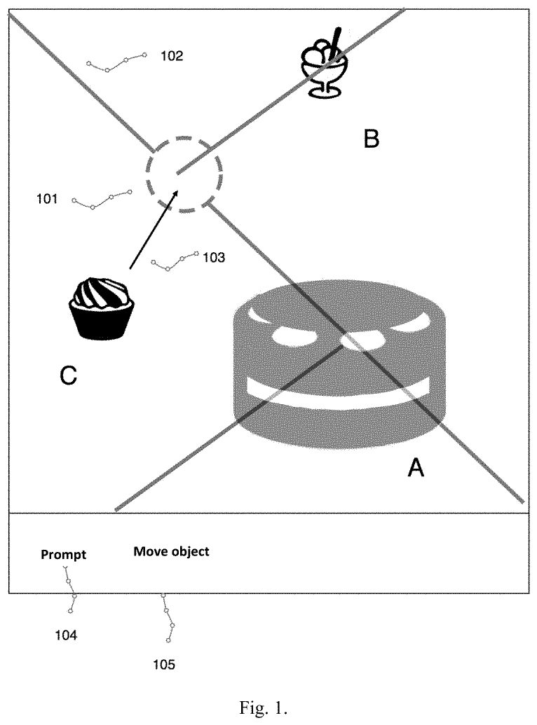

FIG. 1 illustrates a prompt for the user that indicates a position where the object or the whole composition shall be shifted to for obtaining an optimal (according to the composition rule) image. For this purpose the image is analyzed by the processor module for identification of objects and determination of the objects' attributes. Generally (but not obligatory) the image is divided into coordinates or vectors or zones. For the better understanding the image divided into the coordinates will be used in the following explanation. Any specialist may easily carry over the presented information to other variants of division or breakdown of the image. For the objects detected in the image their edges (a set of image coordinates) shall be identified. The degree of sharpness shall be defined by establishing at least one of the values of contrast or color change step in the color range or other for the two adjacent coordinates. It is clear that a part of the object may have the same values for the adjacent coordinates if this part of the object is sole-colored such as a building wall, the sky etc. However, a change in contrast, color or another attribute in particular at the define image edges is considered in this case. Thus, according to this embodiment the need in analyzing the sharpness of the image as a whole is no longer relevant as the sharpness is defined only in the coordinates that describe the object edges in the image. A certain limit is applied for the established values of sharpness, in particular the limit that is characterized by a certain parameter, value etc. Such a limit, for example, may be a step in the range of colors if this step (an absolute difference of color indices) is less than, for example 5, 50, 250 etc. The lesser is the indicated difference the more diffuse is the object edge in the image. Therefore, for any further adjustment of the captured image position the specified limit shall be exceeded.

Then a corresponding mask for identification of the object is called up from the array of template object masks with the use of the processor module and a set of characteristics for defining object attributes is called up from the array of attributes. One should understand that 3D objects in an image are reproduced in 2D space and the possibility of identification of an object may depend on the angle of view in direction of the capturing device. Therefore in identification of objects an adaptive learning system which has been taught to identify objects may be used. The adaptive learning systems mean technical solutions which correct their operation according to processed data. An example of the implemented adaptive learning system is a convolutional neural network. Also hog line point detectors, corresponding filters and others may be applied.

An object mask is characterized by an array of reference values which define the object type and its position, for example: proportions of face elements, the horizon line, determination of objective point. Then a set of characteristics is called up from the array of attributes for determination of attributes of every object in the set of identified objects. Thus the detected image with at least one identified object (the set of identified objects) and attributes of each object is reproduced/called up on the screen.

In detecting an image some changes may occur, for example, of the focus distance (especially when objects move in the image frame or an object is elongated against the capturing device that does not allow setting the same focus to the whole object). This provides additional data on the object for the adaptive learning system and ensures the identification of the object located in the image at carious angles against the capturing device. Thus, the detected image with the identified object and its attributes is reproduced on the screen.

Item (101) denotes a prompt to an area into which object (C) must be transferred. In such a way proposals for correcting the image with the use of the processor module and according to the rules base on the image analysis are given. To determine this area an algorithm based on the output data of the adaptive learning systems identifies the most evident (main) scene objects (A) and/or (B) taking into account the determined values of deviations and analyzing their location relative to the frame and the scene as a whole, makes a conclusion on a zone which is unfilled relative to the whole scene.

In such a way the array of template object masks, the array of object attributes and the array of pre-defined parametric grids of reference images and the screen for reproduction of images are applied.

Item (102) shows an example of a composition grid that is defined on the basis of the image analysis. In such a way the parametric grid of the reference image is produced on the basis of the array of pre-defined reference objects and reproduced on the screen. For this purpose, the parametric grid of the reference image defined on the basis of the array of pre-defined parametric grids of reference images is superimposed on the identified image in real time with accounting for the identified attributes of each object in the set of identified objects. As the obtained image is not ideal from a compositional standpoint it is obvious that the parametric grid of the reference image will provide at least partial coincidence or be located with a certain deviation from the received contours identified on the object image.

Therefore, the values of deviations of each object attributes for the set of detected objects form the parametric grid of the reference image are defined. It is clear that such values may be presented as an array. In this case an average value of deviations is calculated.

Item (103) shows that all main objects (A), (B) and (C) of the image are identified on the basis of the prompt (101). All objects that are not in the area of the superimposed composition grid will be considered as unnecessary (minor) or as those that require transfer into the indicated area defined by the prompt (101).

Items (104) and (105) show localized prompts which describe actions that are necessary for making a composition (in this case the transfer of object (C) into the indicated area). The prompts may be in text or graphic forms, accompanied by voice messages or combinations of these forms.

In the image captured by the capturing device the algorithm identifies main object (A) and minor objects (B) and (C). Then the position of the detected image on the screen is changed until the identified object position and the parametric grid of the reference image coincide.

After adjustment the detected image is saved in a memory. The memory is a carrier of data, generally with a possibility of their rewriting.

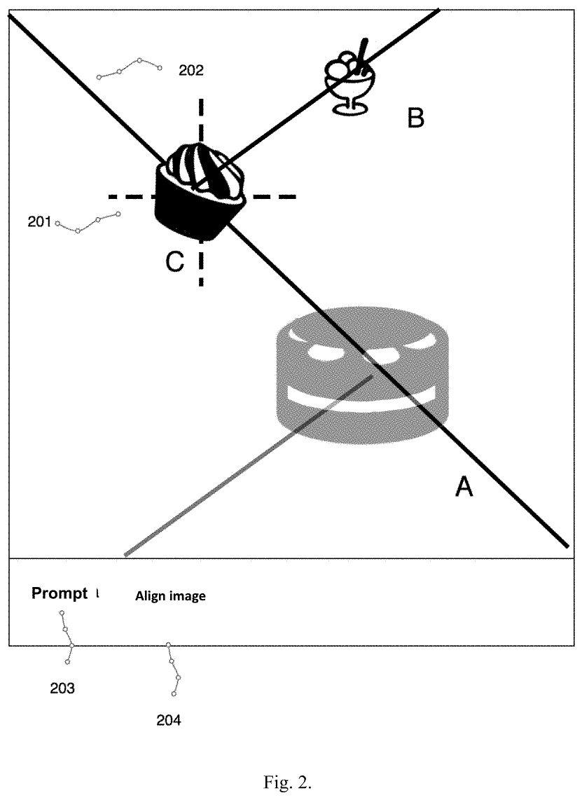

In FIG. 2 item (201) shows a symbol that indicates whether the object (C) is in the area of the superimposed composition grid. For this purpose an algorithm is applied. It analyzes a point, a line or an area of a center of mass with accounting for the object (C). In this case the center of mass should mean a geometrical center of an object relative to its edges.

If the center of mass of the object (C) is in the area of superposition of the composition grid then this position of the object is considered as satisfactory relative to the whole composition.

Item (202) shows a closed area. Finally, when all necessary composition areas in the image are considered as closed the algorithm superimposes the composition grid with the use of an adaptive learning system, at that it will seek to cover the centers of mass of every object in the image.

Then the adjustments on the basis of the given proposals are carried out with the use of the processor module to obtain the adjusted image. For this purpose the localized prompts (203) and (204) in text, graphic. audio formats or combinations thereof (in this case—align the image relative to the position of the composition grid).

The algorithm of the adaptive learning system determines the main object (A) and minor objects (B) and (C) and sends these data to the processor module.

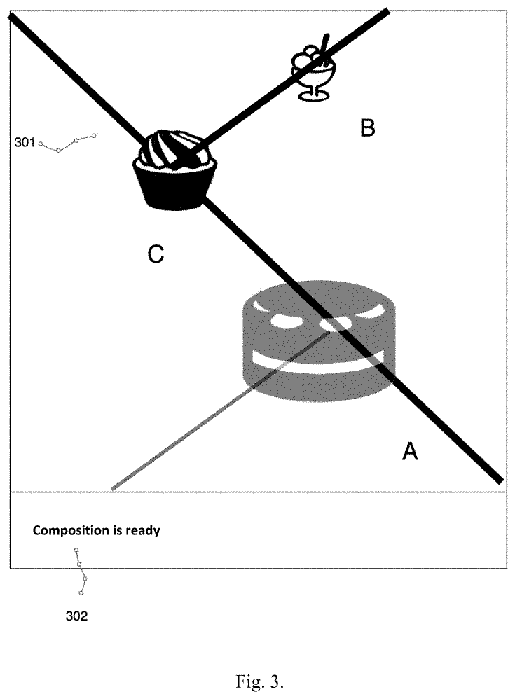

FIG. 3 shows a moment (301) when the image is aligned relative to the composition grid and the user is proposed to save the image at this instant.

At this moment the localized prompt (302) is generated in text, graphic. audio formats or combinations thereof (in this case—save the image at this instant).

In the saved image the main object (A) and minor objects (B) and (C) are indicated.

In such a way the set task is solved and the attainment of the technical result is confirmed. An expert in this field will understand further improvements and modifications of the disclosure on the basis of the essence of the technical solution disclosed in this description.

What is claimed is:

1. A method for positioning of a captured image, comprising:
detecting the image received on a capturing device;
analyzing the image to identify objects and determine attributes of the objects with a use of a processor module;
providing proposals to adjust the image in accordance with rules based on the analysis of the image with the use of the processor module;
adjusting the image on the basis of the proposals provided to obtain an adjusted image with the use of the processor module,
wherein an array of template object masks, an array of object attributes, an array of a pre-defined parametric grid of reference images and a screen for reproducing images are used, and
the images on the capturing device are detected in real time,
a degree of sharpness of the image is determined by identifying objects edges in the image and attaining the pre-defined degree of sharpness with a certain limit value,
a corresponding mask is called up from the array of template object masks with the use of the processor module to identify the object, wherein the object mask is characterized by a set of reference values that define a type of the object and its position, also a set of characteristics is called up from the array of attributes to identify attributes of every object in a set of the identified objects, and a detected image with the set of the identified objects and the attributes of every object in the set of objects is called up on the screen,
parametric grid of one reference image from the array of the pre-defined parametric grids of the reference images is determined on a basis of the image analysis,
the parametric grid of the reference image from the array of the pre-defined parametric grids of the reference images is superimposed on the detected image in real time with accounting for the identified attributes of every object form a set of the detected objects,
values of deviations between the attributes of every object from the array of the detected objects and the parametric grid of the reference image are determined,
recommendations for adjusting a captured image position are generated, wherein an algorithm of recommendations is based on an output data of adaptive learning systems and takes into account the determined value of the deviation,
a position of the detected image on the screen is changed until the position of the identified object and the parameters of reference image are matched,
the detected image is saved in a memory.
